(19) United States
(12) Patent Application Publication
(10) Pub. No.: US 2009/0293688 A1
(43) Pub. Date: Dec. 3, 2009

(54) Metal forming machine and method for spinning/flow forming

(76) Inventors: Benedikt Nillies, Ahlen (DE); Werner Huetter, Ahlen (DE)

Correspondence Address: JACOBSON HOLMAN PLLC, 400 SEVENTH STREET N.W., SUITE 600, WASHINGTON, DC, 20004, US

(21) Appl. No.: 12/155,251

(22) Filed: May 30, 2008

(51) Int. Cl. B23B 3/34; B23B 3/20; F28F 13/00

(52) U.S. Cl. 82/129; 82/122; 165/108

(57) ABSTRACT

The invention relates to a metal working or forming machine and a spinning/flow forming method. A main spindle is provided and can be driven in rotary manner about a vertically directed rotation axis. Furthermore, a tailstock spindle can be driven in rotary manner about a rotation axis and is coaxial to the main spindle. A machine lower bed and a machine upper bed are interconnected by means of vertically directed machine columns. At least one working roll is radially infeedably guided. According to the invention at least three machine columns are arranged distributed around the rotation axis, which define a working area and form three lateral passage or transit areas. At the first passage area is provided a supply device and at the second passage area a removal device. At the third passage area is provided a machining unit, which is readily detachable and removable for forming an access to the working area.

The invention relates to a metal working or forming machine for spinning/flow forming according to the features of the preamble of claim 1. The invention also relates to a spinning/flow forming method according to the preamble of claim 11.

Metal forming machines with vertically directed rotation axis have long been known. Such a forming machine being disclosed by DE-U-91 03 358.6. This forming machine has a machine lower bed and a machine upper bed, which are separated from one another by means of two vertically directed machine columns. On both the machine lower bed and machine upper bed drives are provided for the separate driving of the main spindle and the tailstock spindle. However, the rigidity of the machine frame is limited when using two machine columns.

An increased machine frame rigidity results from the provision of three machine columns, such as is e.g. known from DE-OS 1 941 937. In the case of said forming machine the main spindle and the single drive motor are placed on the machine upper bed. A total of three working rolls are mounted on a roughly triangular support guided along all three machine columns. With this arrangement access to the working area with the main spindle and the working tool is limited.

Further similar forming machines with a vertical construction are known, in which the main spindle and working tool are placed on the machine lower bed.

The object of the invention is to provide a metal forming machine and a spinning/flow forming method, which leads to a high machine rigidity and at the same time a good accessibility to the working area, so that also an additional machining is also possible.

The object of the invention is achieved by a forming machine having the features of claim 1 and a method having the features of claim 11. Preferred embodiments of the invention are given in the dependent claims.

The metal forming machine according to the invention is characterized in that at least three machine columns are distributed around the rotation axis, which defines a working area and between which are correspondingly formed three lateral passage or transit areas to the working area, that at a first passage area a supply device for supplying workpieces to the rotation axis is arranged, that at a second passage area a removal device for removing the worked workpieces from the rotation axis is arranged and that at a third passage area there is at least one machining unit, which is easily detachable and/or removable for forming an access to the working area.

According to a first aspect of the invention the supply and removal of the workpieces are spatially separated and distributed over two different passage areas. This improves the material flow and provides at both passage areas a greater free space for accessing the working area. According to the invention, at the at least one further, third passage area there is a machining unit with which an additional machining for spinning and/or flow forming can be implemented. According to another aspect of the invention this machining unit is such designed that it can be easily removed from the third passage area. This can take place using a quick-action clamping mechanism, a horizontal or vertical shifting mechanism or a swivel bearing. The machining unit can be reliably anchored to the machine frame using suitable quick-action clamping or quick-fixing systems and, if necessary, can be rapidly released again. The machining unit is also integrated into the automatic sequence of operations in the same way as the other machining components.

All in all, this leads to a vertical forming machine, which provides an excellent material flow and an additional machining function with at the same time further high accessibility and inspection to the working area with the main spindle and the working tool.

Basically, the machining unit can be provided for any desired function and can in particular take also over measuring and testing functions. According to the invention it is particularly preferable for the machining unit to have a working roll, a splitting device, a cross-rolling device, a cutting device for cutting or chip-forming machining, a heat supply device and/or a changing device for the working tool. As a result the functionality of a vertical forming machine and therefore its intended use are significantly improved.

Another advantageous embodiment of the invention resides in the fact that the tailstock spindle together with the second drive are located on a slide, which is axially displaceably guided along the machine columns. Generally, the tailstock spindle is used for axially pressing the workpiece onto the working tool, the so-called spinning chuck, on the main spindle. The tailstock spindle can be equipped with a working tool. With the inventive arrangement of drives both the main spindle and the tailstock spindle can be operated with an exact speed synchronization for precise working or forming. With a high working performance or other applications a torque-controlled operation is also possible. With the axial displacement of the tailstock spindle this is in particular ensured in that the tailstock spindle together with the second drive are moved on a slide, which is displaceably mounted along the machine columns.

A particularly rigid frame construction is inventively achieved in that each machine column has two box-like pillars between which a free space is formed and in the free space is displaceably guided at least one roll support for the working roll. Thus, the roll support can be vertically moved in the machine column. In the actual machine support is provided a horizontal positioning device with which the working roll can be moved and infed radially with respect to the rotation axis.

It is also preferable according to the invention for the supply device and/or removal device to have a gripper and a conveyor. The conveyor can in particular be a horizontal conveyor, such as a conveyor belt or roller conveyor. A gripper permits a rapid and precise work supply and only limited space is needed.

Generally, if necessary, the supply device and removal device can have different designs. However, according to the invention, it is particularly advantageous for the supply device and removal device to have identical constructions. This in particular reduces manufacturing costs and simplifies maintenance work.

The inventive metal forming machine with rapid supply and removal of workpieces is particularly advantageous for short cycle times. To this end, according to the invention a heating device is provided on the working tool and/or tailstock spindle. As a result it is provided that the workpiece is excessively cooled during forming and the workpiece temperature drops below a desired operating temperature. The heating device is more particularly electrically operated and preferably has heating coils. Gas burners can also be provided for the heat supply.

According to a preferred embodiment of the inventive forming machine, a cooling device is provided on the spindles, working tool and/or working rolls with which heat can be dissipated by means of a liquid coolant. This can prevent in comparable manner that the heat produced during forming raising the workpiece temperature above an intended operating temperature, so that a clearly defined temperature control is possible. This can be advantageous both for a hot forming and cold forming with a clearly defined strain hardening. At the start of a working process initially heating can take place in order to avoid workpiece cooling. Subsequently cooling can take place to keep a clearly defined workpiece temperature level.

A preferred development of the invention resides in the fact that the cooling device has a coolant simultaneously serving as a lubricant. This means that the lubricant circuit with lubricating oil simultaneously serves as a coolant circuit. To this end in said circuit is integrated at least one heat exchanger, so that the lubricant and coolant can be kept at a clearly defined temperature level. According to the invention the coolant is recycled in a closed loop via a storage tank, which can be actively cooled.

The inventive method is characterized in that a workpiece is supplied via a first passage area to the working area and that following spinning/flow forming the workpiece is removed from the working area via a second passage area. With said method it is possible to bring about the corresponding advantages when using the above-described metal forming machine. The inventive method comprises both the spinning, during which a sheet metal workpiece is formed, without significantly modifying the sheet material wall thickness, and also the flow forming, during which the sheet thickness is increased or decreased. A combination of spinning and flow forming can also take place.

During a loading and unloading process, by means of the control mechanism for axial tailstock displacement and the radial or axial support adjustment, it is possible to approach random intermediate positions in order to bring about short displacement paths.

The stand-alone inventive subjects within the application are constituted not solely by the entire machine as well as the method, but also the individual machine components, as can be gathered from the description. These individual components worthy of protection are in particular the drive means, cooling device, additional machining unit, spindles, supply and removal device as well as the machine control mechanism.

The invention is described in greater detail hereinafter relative to preferred embodiments which are diagrammatically illustrated in the attached drawings, wherein show:

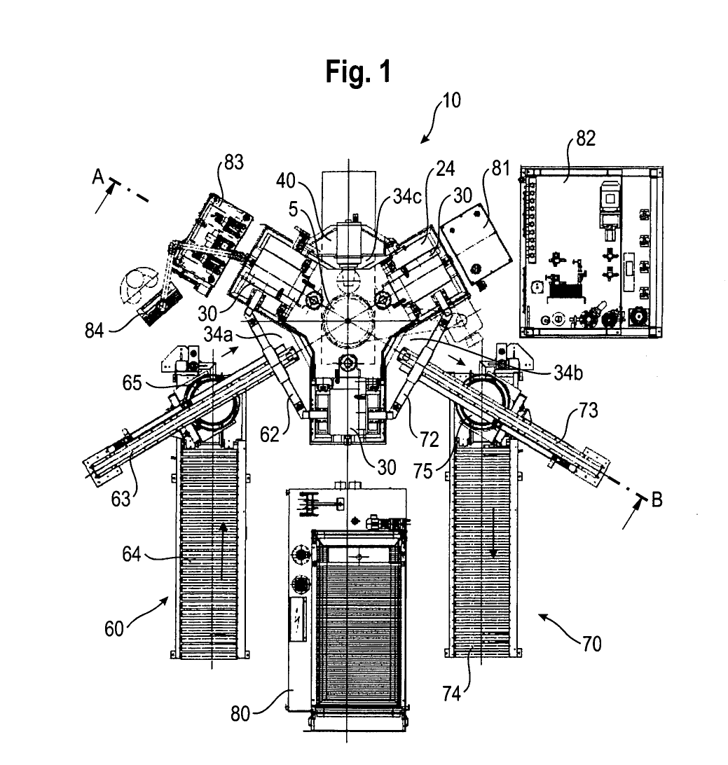

FIG. 1: A plan view of an embodiment of an inventive metal forming machine;

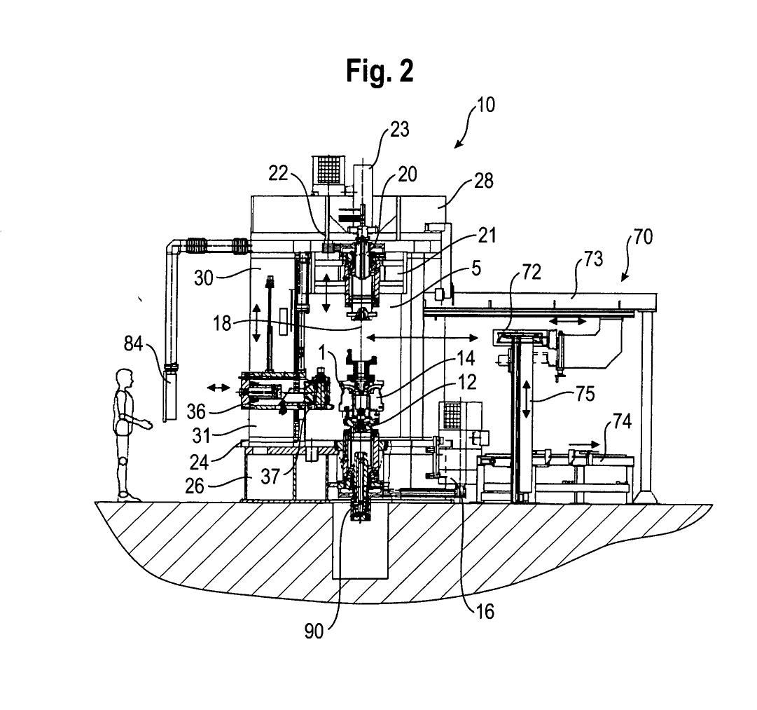

FIG. 2: A cross-sectional view of the machine of FIG. 1 with ejector along section A-B;

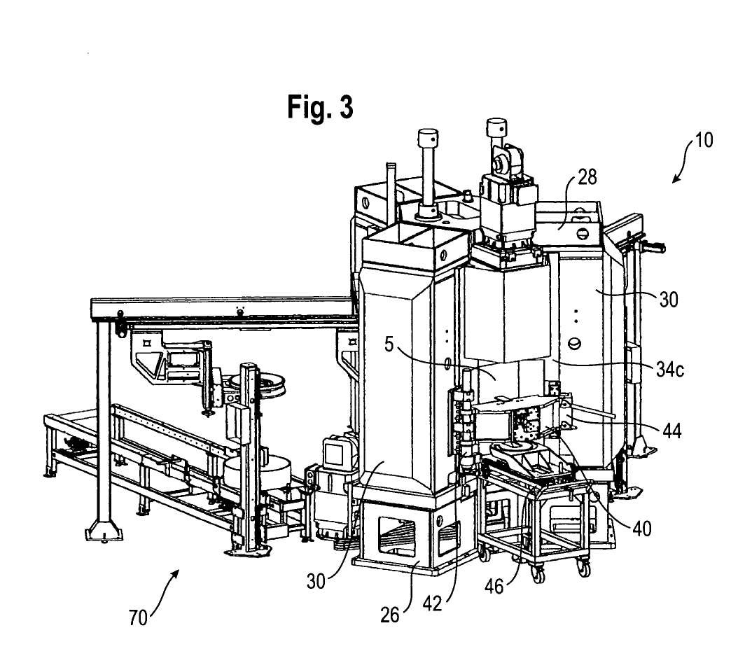

FIG. 3: A perspective view of the machine of FIG. 1;

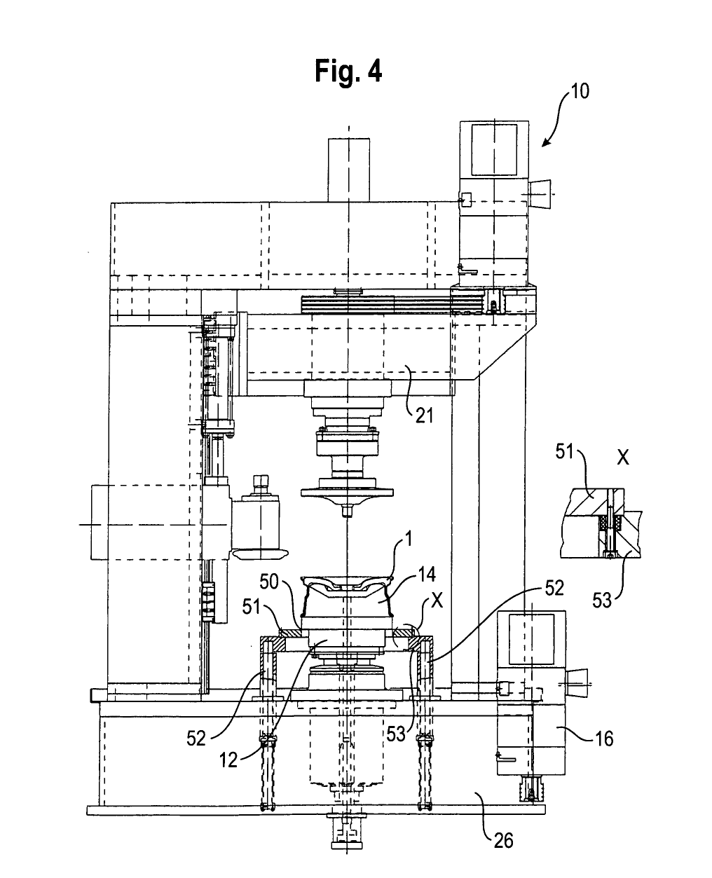

FIG. 4: A diagrammatic cross-sectional view through a spindle area with stripper;

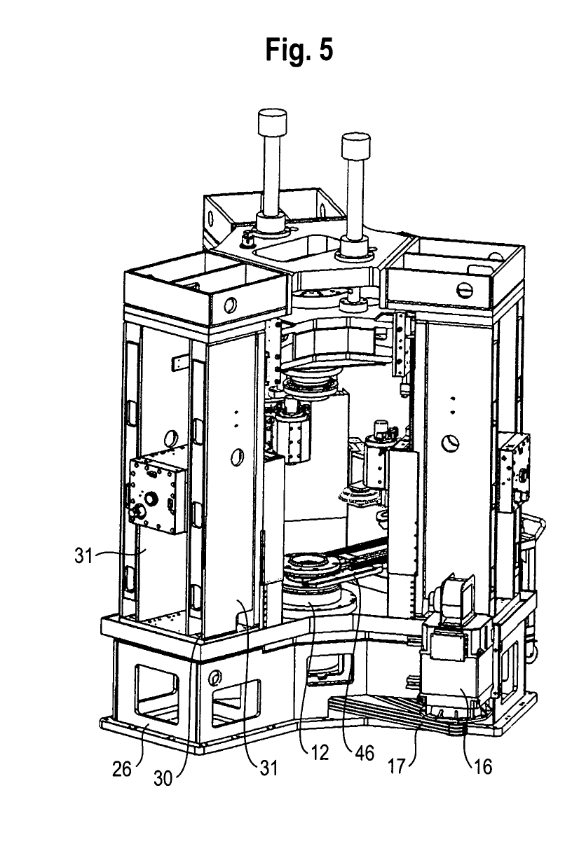

FIG. 5: A perspective view of the spindle area; and

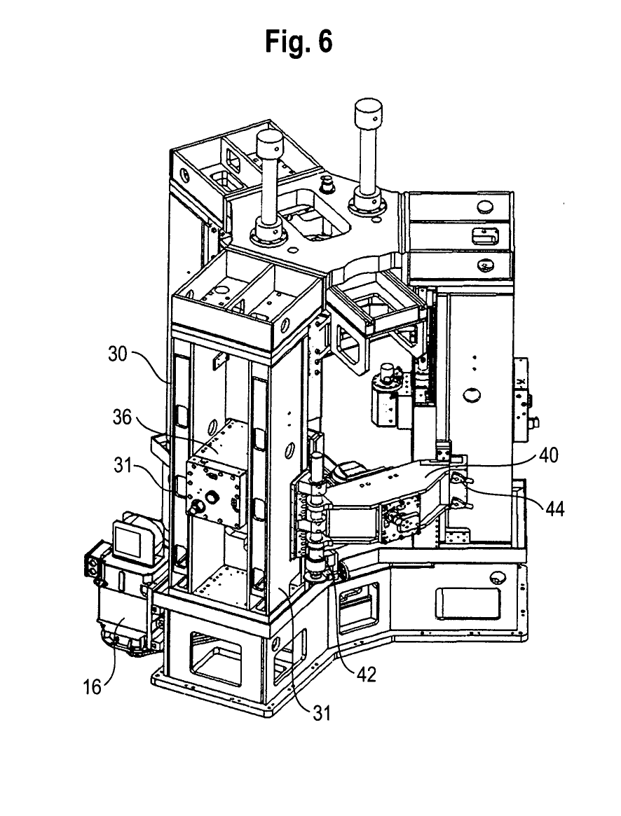

FIG. 6: A perspective view of the additional machining station.

The fundamental structure of an inventive metal working or forming machine 10 is illustrated by the embodiment according to FIGS. 1 to 3. In the view from above of FIG. 1 it is possible to see a star-shaped machine frame 24 with three columns 30. Between the three vertical machine columns 30 are provided a first passage area 34a, a second passage area 34b and a third passage area 34c through which access is achieved to an inner working area 5.

At the first passage area 34a is arranged a supply device 60 with a conveyor belt as conveyor 64 and a gripper 62. Gripper 62 is horizontally displaceable by means of a linear feed unit 63 and vertically displaceable by means of a lifting unit 65, in order to convey a workpiece from conveyor 64 to working area 5.

At the second passage area 34b is arranged a removal device 70 with a roller conveyor as conveyor 74 and a gripper 72. In the same way as for the supply device 60, gripper 72 is vertically adjustable by means of a lifting unit 75 and horizontally adjustable by means of a linear feed unit 73 in order to convey a finished workpiece out of working area 5 and place the same on conveyor 74.

At the third passage area 34c is provided an additional machining unit 40, which will still be explained in greater detail hereinafter.

As further components the forming machine 10 incorporates a coolant unit 80 with belt filters and heat exchangers, which keep the coolant and washing liquid for spraying the workpiece at a desired temperature level and removing contamination from the same prior to a return. A cooling device 81 is also provided. As a result all heat-sensitive machine components, such as the main spindle bearing, roller bearings and tailstock bearings can be correspondingly cooled. The working tools or spinning chuck receptacle can also be cooled. For this purpose corresponding cooling lines in and to the components are installed. For the recooling of the coolant a water-heat exchanger is installed on a coolant tank of the cooling device 81. A water supply is controlled by means of a thermostat with water valve.

A hydraulic station 82 is also provided and is also equipped with a heat exchanger. The hydraulic station 82 is used for pressure fluid supply. The forming machine 10 also has a lubricating device 83, which is in particular provided for spindle and roller bearings. The lubricating device 83 and hydraulic station 82 incorporate a thermostatting device with which the lubricating oil and hydraulic oil are cooled or can optionally be preheated using a time switch, so that at the start of operation a reliable lubrication is ensured. The forming machine 10 can be controlled by means of control console 84.

According to FIG. 2 machine frame 24 has a machine lower bed 26 and a machine upper bed 28, which are fixedly interconnected by means of the three vertical machine columns 30.

On machine lower bed 26 is provided a main spindle 12 with a working tool 14 for receiving a workpiece 1. By means of a first drive 16 main spindle 12 with working tool 14 are rotated about rotation axis 18. An ejector unit 90 is provided below main spindle 12. Ejector unit 90 is used for loading-transfer of workpiece 1 from supply device 60 for the positioning and clamping of workpiece 1 on rotation axis 18 with subsequent clamping to the working tool 14, as well as for unloading, breaking off and stripping the workpieces 1 from working tool 14 with subsequent transfer to removal device 70.

Ejector unit 90 has a bayonet-like rapid closure, which is flanged to the back of the spindle bearings and an ejector rod is guided through a hollow drilled main spindle 12. The ejector rod is equipped with a bayonet-like rapid connection in order to permit a rapid and easy changing of working tool 14. Ejector unit 90 is used for loading-transfer of workpiece 1 from supply device 60 to the positioning and clamping of workpiece 1 on rotation axis 18 with subsequent fixing to the working tool 14—and respectively to unloading, breaking off and stripping workpiece 1 from working tool 14 with subsequent transfer to the removal device 70.

On the main spindle side ejector unit 90 has a double stroke cylinder with a large piston surface, which permits a high feed force for a low feed speed and a small stroke or lift for breaking off workpieces 1 from working tool 14. There is also a small piston surface for a low feed force and high feed speed with a large stroke or lift for the rapid conveying of workpieces 1 into the loading or unloading position.

If the workpieces 1 are aluminium wheels, the ejector unit appropriately engages in the wheel centre so as not to damage the sensitive aluminium workpiece. In the wheel centre the wall thickness is at highest.

At machine upper bed 28 is provided a second drive 22, which by means of a conventional gear mechanism drives in rotary manner a tailstock spindle 20 about rotation axis 18. Tailstock spindle 20 and the second drive 22 are mounted on a horizontally directed, plate-like slide 21, which is axially displaceable along the vertical machine columns 30. To this end hydraulic positioning cylinders 23 are provided on machine upper bed 28. Main spindle 12 and the tailstock spindle 20 coaxial thereto are placed in the working area 5, which is defined by the three machine columns 30.

Each machine column 30 is formed from two box-like pillars 31, between which a free space is formed. Roll supports 36 with a working roll 37 are infeedably mounted in said free space. The radial roll supports 36 are horizontally oriented. The three radial roll supports 36 are mutually displaced by 120°. The radial feed drive in the case of the embodiment shown is brought about by a servocontrolled hydraulic cylinder and axially the vertical adjustment takes place by means of a servocontrolled hydraulic cylinder. They can also be electrical. The roll supports 36 are mechanically completely independently of each other displaceable in each case with a radial and axial infeed for the working rolls 37.

According to FIG. 3 an additional machining unit 40 for carrying out a further machining operation on the workpiece is provided at the third passage area 34c. Machining unit 40 comprises a trapezoidal box or case which, according to FIG. 3, is pivotably articulated to a vertically directed shaft 42 on the left-hand machine column. On the right-hand side of machining unit 40 is provided a rapid fixing device 44 by means of which said side of the machining unit 40 can be releasably fitted to the right-hand machine column 30. If access to working area 5 is desired, following the release of the rapid fixing device 44, machining unit 40 can be pivoted aside about shaft 42. It is then possible, for example by means of a horizontally movable carriage to move up a changing device 46 with which e.g. the working tool 14 can be easily changed in the working area 5. Following the changing process the machining unit 40 can be pivoted back and locked.

The use of the changing device 46 is clearly illustrated in FIG. 5. FIG. 5 also shows the structure of a machine column 30 with the two parallel to each other running box-like pillars 31. The first drive 16 for driving the main spindle 12 is fitted laterally to machine lower bed 26 and the torque is transmitted by means of a toothed belt.

The placing of a roll support 36 between the two box-like pillars 31 of a machine column 30 is also clearly illustrated in FIG. 6. FIG. 6 also clearly shows the pivotable mounting of the machining unit 40 with shaft 42 and the rapid fixing device 44.

An inventive stripper unit 50 is clearer specified in connection with FIG. 4. A stripping plate 51 is flanged to the back of the bearing of the main spindle 12. Using hydraulic stripping cylinders 52 stripping plate 51 can be moved vertically upwards for stripping the finished workpiece 1 from the working tool 14. Stripping plate 51 is connected by lower ring or band 53 to stripping cylinders 52. For a rapid change of stripping plate 51 it is readily detachably screwed by means of threaded bolts to elastic lower ring 53, as can be gathered from detail X.

Stripper unit 50 is held above machine lower bed 26 by at least two hydraulic stripping cylinders 52 with strong and long guides. The annular closed stripping plate 51 engages on elastic lower ring 53. As a result it is possible to compensate unevennesses on the edge of workpiece 1, so that the annular stripping plate 51 fully engages on its underside with workpiece 1 and as a result a clamping or tilting of workpiece 1 is prevented. Like the above-described ejector unit 90, stripper unit 50 is used for the transfer of workpiece 1 from supply device 60 during loading and respectively the delivery of workpiece 1 to removal device 70 on unloading.

1. Metal forming machine for spinning/flow forming having
a vertically directed main spindle on which is provided a working tool,
a first drive with which the main spindle can be driven in a rotary manner about a vertically directed rotation axis,
a tailstock spindle positioned coaxially to main spindle and axially movable relative thereto,
a second drive with which tailstock spindle can be driven in a rotary manner about the rotation axis,
a machine lower bed and a machine upper bed, which are interconnected by means of vertically directed machine columns and
at least one working roll, which is axially displaceably and radially infeedably guided along at least one machine column,
wherein
at least three machine columns are distributed about rotation axis, which define a working area and between which are correspondingly formed at least three lateral passage areas to the working area,
at a first passage area is provided a supply device for supplying workpieces to the rotation axis,
at a second passage area is provided a removal device for removing formed workpieces from rotation axis, and
at a third passage area is provided at least one machining unit, which is easily releasable and/or removable for forming an access to the working area.

2. Metal forming machine according to claim 1,
wherein
the machining unit has a working roll, a splitting device, a cutting device for cutting or chip forming machining, a thermostatting device and/or a changing device for the working tool.

3. Metal forming machine according to claim 1,
wherein
the tailstock spindle together with the second drive is located on a slide, which is axially displaceably guided along machine columns.

4. Metal forming machine according to claim 1,
wherein
each machine column has two box-like pillars between which is formed a free space and
in said free space is displaceably guided at least one roll support for working roll.

5. Metal forming machine according to claim 1,
wherein
the supply device and/or removal device have a gripper and a conveyor.

6. Metal forming machine according to claim 1,
wherein
the supply device and removal device are constructed identically or homologously.

7. Metal forming machine according to claim 1,
wherein
a heating device is provided on working tool and/or on the tailstock spindle.

8. Metal forming machine according to claim 1,
wherein
a cooling device is provided on spindles, working tool and/or working rolls enabling a dissipation of heat by means of a liquid coolant.

9. Metal forming machine according to claim 8,
wherein
the cooling device has a coolant simultaneously serving as a lubricant.

10. Metal forming machine according to claim 8,
wherein
the coolant is recycled in a closed loop via a storage tank which can be actively cooled.

11. Method for spinning/flow forming with a metal forming machine according to claim 1,
wherein
a workpiece is supplied to the working area via a first passage area and
following spinning/flow forming, the workpiece is removed from working area via a second passage area.
